(19) United States
(12) Patent Application Publication
(10) Pub. No.: US 2014/0152980 A1
(43) Pub. Date: Jun. 5, 2014

(54) INSPECTION DEVICE FOR SUBSTRATE DEFORMATION AT HIGH TEMPERATURES AND INSPECTION METHOD FOR SUBSTRATE DEFORMATION AT HIGH TEMPERATURES USING THE SAME

(71) Applicant: SAMSUNG ELECTRO-MECHANICS CO., LTD., Suwon (KR)

(72) Inventors: Gyu Seok KIM, Suwon (KR); Hee Suk CHUNG, Suwon (KR); Suk Jin HAM, Suwon (KR); Dong Yong KIM, Suwon (KR); Yong Choon PARK, Suwon (KR); Mi Yang KIM, Suwon (KR); Tae Yoon KIM, Suwon (KR)

(73) Assignee: SAMSUNG ELECTRO-MECHANICS CO., LTD., Suwon (KR)

(21) Appl. No.: 13/772,491

(22) Filed: Feb. 21, 2013

(30) Foreign Application Priority Data
Dec. 3, 2012 (KR) 10-2012-0139253

(51) Int. Cl. G01N 1/28

(52) U.S. Cl. CPC G01N 1/28
USPC 356/244

(57) ABSTRACT

There are provided an inspection device for substrate deformation at high temperatures and an inspection method for substrate deformation at high temperatures, the inspection device for substrate deformation at high temperatures, including a crucible including an internal space, an inspection hole disposed in an upper portion thereof so as to inspect the internal space, and a heating unit heating the internal space, an indenter tip disposed in the crucible such that a substrate fixed to the internal space is warped, and an inspection unit disposed above the crucible so as to inspect a cross-section of the substrate.

### CROSS-REFERENCE TO RELATED APPLICATIONS

This application claims the priority of Korean Patent Application No. 10-2012-0139253 filed on Dec. 3, 2012, in the Korean Intellectual Property Office, the disclosure of which is incorporated herein by reference.

### BACKGROUND OF THE INVENTION

1. Field of the Invention

The present invention relates to an inspection device for substrate deformation at high temperatures and an inspection method for substrate deformation at high temperatures using the same.

2. Description of the Related Art

For the miniaturization of electronic components, demand for reductions in substrate thickness has been increased. In the case that the thickness of a substrate is reduced, warpage of the substrate occurring during various stages such as in the manufacturing or in the utilization of the substrate, and the like, has a significant effect on product reliability and performance. As a result, it is very important to determine where the warpage of a substrate occurs to some degree and how the warpage affects products. In particular, since a substrate is frequently formed to have multiple layers using various materials, cracks or delamination may easily occur in the substrate with the increased warpage.

Generally, when the warpage of a substrate occurs, a central portion of the substrate is depressed downwardly and an outside of the substrate is protruded or the central portion of the substrate is protruded and the outside of the substrate is depressed. In this case, stress may be concentrated on the inside of the substrate, such that cracks or delamination may easily occur in the substrate. For inspecting behaviors of the substrate on a micro scale, when inspecting the substrate using a scanning electron microscope, the depressed shape of the substrate may be inspected, but cracks or delamination due to the stress concentration occurring in the substrate may not be inspected.

However, a device for analyzing the internal deformation of the central portion of the substrate at the high temperatures has not yet been provided. Even when the high temperature is applied to the substrate, no method for inspecting the inside of the substrate is present.

The following related art document discloses a tester capable of applying tensile force to a sample, but does not disclose a device capable of inspecting the internal deformation of the substrate at high temperatures.

### RELATED ART DOCUMENT

(Patent Document 1) US Patent Laid-Open Publication No. 2002/0167988

### SUMMARY OF THE INVENTION

An aspect of the present invention provides an inspection device for substrate deformation at high temperatures capable of inspecting internal deformation of a substrate at high temperatures and an inspection method for substrate deformation at high temperatures using the same.

According to an aspect of the present invention, there is provided an inspection device for substrate deformation at high temperatures, the inspection device including: a crucible including an internal space, an inspection hole disposed in an upper portion thereof so as to inspect the internal space, and a heating unit heating the internal space; an indenter tip disposed in the crucible such that a substrate fixed to the internal space is warped; and an inspection unit disposed above the crucible so as to inspect a cross-section of the substrate.

The inspection hole may be covered with a transparent window.

The crucible may be enclosed by a heat insulation material.

The inspection device for substrate deformation at high temperatures may further include: a control unit interconnected with the indenter tip to control movements of the indenter tip.

The control unit may determine force applied to the indenter tip according to displacement of the indenter tip and determine correlation therebetween to store determined results in a memory.

The control unit may control an objective lens of the inspection unit to move toward a target cross-section of the substrate and allows data inspected by the inspection unit to be stored in a memory.

The control unit may control the heating unit to heat the internal space to a target temperature.

The crucible may be provided in seating grooves facing each other and having both ends of the substrate fitted therein.

According to another aspect of the present invention, there is provided an inspection method for substrate deformation at high temperatures, the inspection method including: heating a crucible including an internal space having a substrate mounted therein and polished so as to expose a target cross-section of the substrate, to a target temperature; warping the target cross-section of the substrate to a target displacement by an indenter tip disposed in the crucible; and inspecting the target cross-section by an inspection unit.

The target displacement may be a difference between degrees of deformation in the target cross-section of the substrate before the substrate is polished and the target cross-section of the substrate after the substrate is polished, at the target temperature.

The target cross-section may include a central portion of the substrate before the substrate is polished.

The warping may include measuring force applied to move the substrate by an amount equal to the target displacement by the indenter tip.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating warpage occurring in a substrate at high temperatures;

FIG. 2 is a perspective view illustrating warpage of a part of the substrate occurring at high temperatures after the substrate is taken along line A-A′ of FIG. 1;

FIG. 3 is a comparison graph illustrating degrees of deformation of the substrate of FIG. 1 and the part of the substrate of FIG. 2 taken along line A-A′, at high temperatures;

FIG. 4 is a perspective view of an inspection device for substrate deformation at high temperatures according to the embodiment of the present invention;

FIG. 5 is a cross-sectional view of line B-B′ of FIG. 4;

FIG. 6 is a cross-sectional view of line C-C′ of FIG. 4; and

FIG. 7 is a flow chart illustrating a sequence of an inspection method for substrate deformation at high temperatures according to an embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

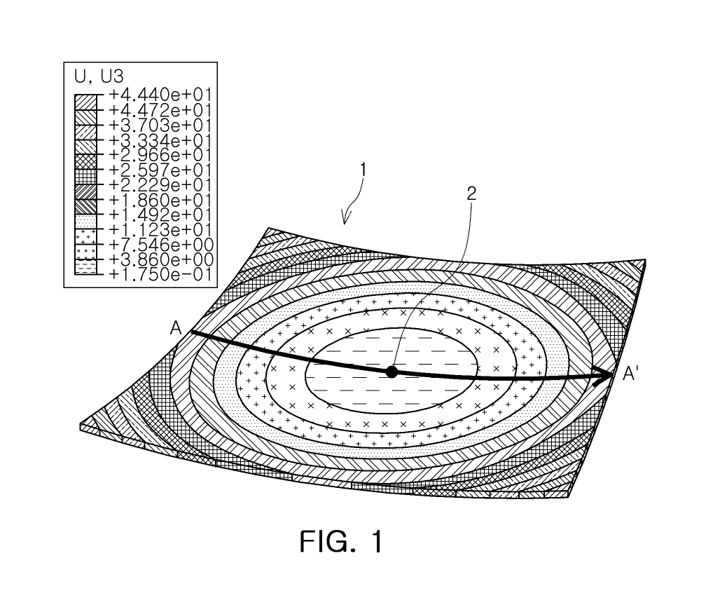

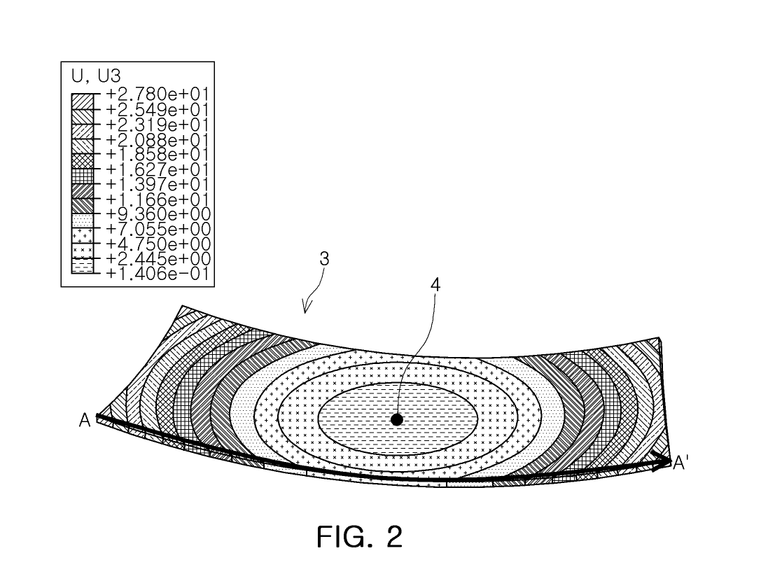

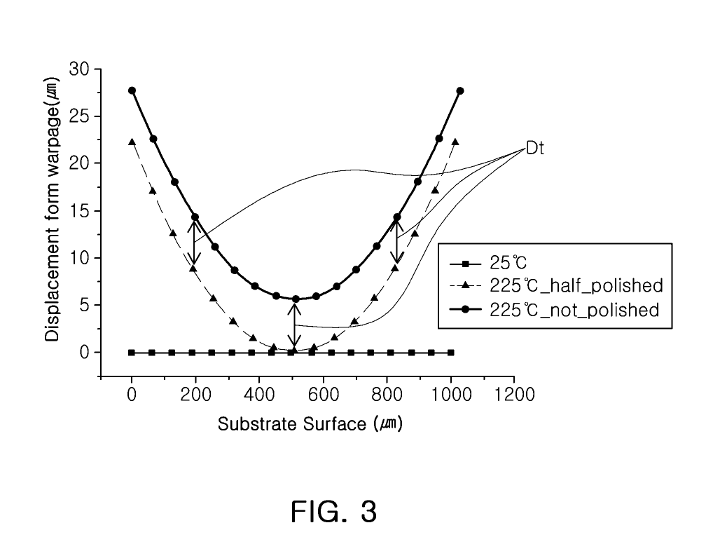

FIG. 1 is a perspective view illustrating warpage occurring in a substrate at high temperatures. FIG. 2 is a perspective view illustrating warpage of apart of the substrate occurring at high temperatures after the substrate is taken along line A-A′ of FIG. 1. FIG. 3 is a comparison graph illustrating degrees of deformation of the substrate of FIG. 1 and the part of the substrate of FIG. 2 taken along line A-A′, at high temperatures.

FIG. 1 illustrating a substrate 1, to be subjected to high temperature deformation inspection in an embodiment of the present invention. The substrate 1 illustrated in FIG. 1 is in a heated state at a predetermined temperature. The substrate 1 is a multilayer substrate and materials configuring respective layers may be different. Therefore, when the substrate 1 is disposed at high temperatures, the warpage of the substrate may occur due to a difference in a thermal deformation rate between the materials configuring respective layers.

As illustrated in FIG. 1, the warpage of the substrate 1 may occur. A central portion of the substrate 1 is depressed downwardly while a circumferential portion of the substrate is protruded upwardly. In this manner, stress is concentrated on the central portion of the substrate 1, such that cracks or delamination may easily occur in the substrate. For inspecting behaviors of the substrate on the micro scale, when inspecting the substrate using a scanning electron microscope, the depressed shape of the substrate may be inspected, but the cracks or the delamination due to the stress concentration occurring in the substrate may not be inspected.

When the substrate having a predetermined size is disposed at a predetermined temperature, the deformation or distortion, and the like, of the substrate may occur. In this case, there is a need to determine internal behavior characteristics of the substrate. The substrate may be used in various situations, and therefore there is a need to determine the critical situation of the substrate. In particular, the substrate is formed to have multiple layers, such that the deformed amount of each layer may be different depending on a thermal load acting thereon. Therefore, there is a need to determine the internal behavior of the substrate depending on warpage thereof when the substrate is at high temperatures.

However, there is no method of accurately observing the inside of the substrate 1 at present. A method of substantially observing a cut surface of the substrate 1 by cutting the substrate 1 is the most preferable. However, when heat is applied to a cut substrate 2 obtained by cutting (or polishing, hereinafter referred to the same meaning) the substrate 1 along line A-A′ of FIG. 1 in order to inspect the internal behaviors of the central portion of the substrate 1, warpage occurs as illustrated in FIG. 2.

As illustrated in FIG. 2, a portion of the cut substrate 2, cut along line A-A′ corresponds to an edge portion, rather than the central portion of the substrate. Therefore, the portion of the substrate 1, cut along line A-A′, corresponding to the central portion of the substrate 1 before the cutting of the substrate 1 may correspond to the edge portion of the cut substrate 2, such that even in the case in which the cut substrate 2 is disposed at high temperature conditions, the portion of the cut substrate 2, cut along line A-A′ is a free end, and therefore warpage behaviors thereof are entirely changed.

FIG. 3 is a comparison graph illustrating degrees of deformation of the substrate of FIG. 1 (before the cutting of the substrate 1) and the cut substrate 2 of FIG. 2, taken along line A-A′, under high temperature conditions, for example, at 225° C., as illustrated in FIG. 3.

It can be appreciated that both substrates 1 and 2 are warped at the high temperature conditions of 225° C. However, there is a difference in that the cut substrate 2 is not warped at a portion thereof corresponding a substrate surface of 500 μm that is approximately the central portion along the line A-A′, while the substrate 1 prior to the cutting is warped. That is, when the substrate 1 is cut to inspect the internal behaviors in the central portion of the substrate 1, warpage deformation is changed according to high temperature conditions at the same position.

Therefore, as an inspection device 100 for substrate deformation at high temperatures according to the embodiment of the present invention, a tester to identically cause warpage deformation of the cut substrate 2 even under high temperature conditions is provided.

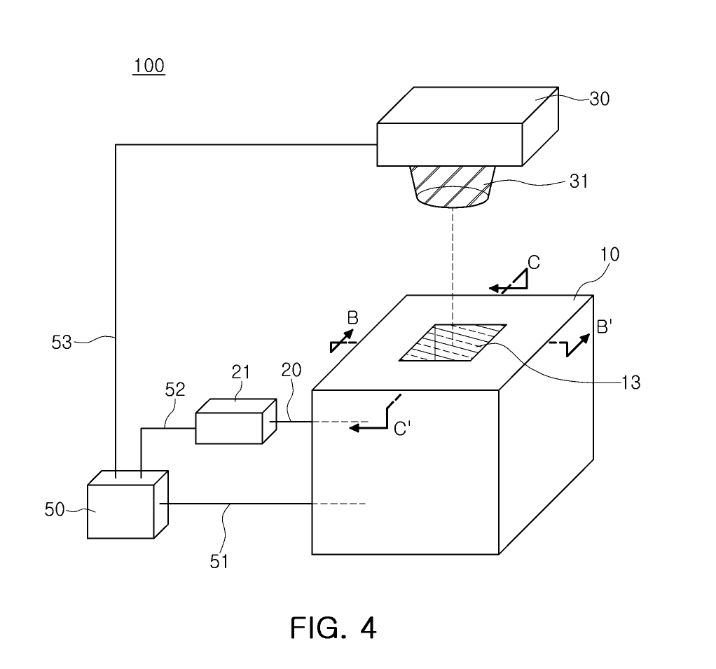

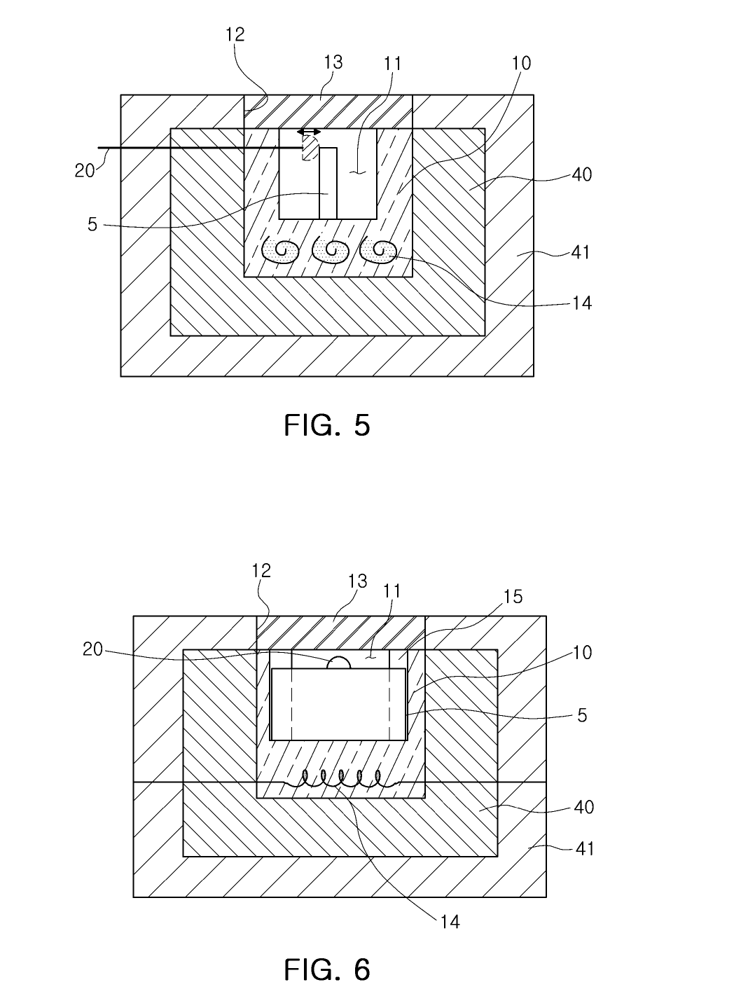

FIG. 4 is a perspective view of an inspection device for substrate deformation at high temperatures according to the embodiment of the present invention; FIG. 5 is a cross-sectional view of line B-B′ of FIG. 4; and FIG. 6 is a cross-sectional view of line C-C′ of FIG. 4.

Referring to FIGS. 4 through 6, the inspection device 100 for substrate deformation at high temperatures according to the embodiment of the present invention may include a crucible 10, an indenter tip 20, and an inspection unit 30. Further, the inspection device 100 may include a control unit 50 capable of controlling respective components. Hereinafter, respective components will be described in detail.

The crucible 10 may include an internal space 11, an inspection hole 12 disposed in an upper portion thereof to allow for an inspection of the internal space 11, and a heating unit activating the internal space 11 at high temperature conditions. The crucible 10 may be formed to have a sealed structure, other than the upper portion of the crucible in which the inspection hole 12 is disposed. Further, the crucible 10 may be formed of a material having excellent heat insulating properties. Further, the crucible 10 is not necessarily formed of a heat insulating material, but may be formed of a material having slightly degraded heat insulation properties as long as the high temperature condition can be maintained due to various heating units.

The crucible 10 may include the internal space 11. A substrate 5 to be tested may be fixed to the internal space 11 and mounted therein. Therefore, the crucible 10 may be provided with seating grooves 15 opposing each other and having both ends of the substrate 5 fitted therein and fixed thereto. That is, since the substrate 5 may be warped, such that the substrate may be fixed to the internal space 11 in a state in which the internal space 11 is sufficiently wide. Therefore, the substrate 5 may be fixed to the internal space 11 while passing through the internal space 11. Therefore, the seating grooves 15 may be provided in the internal space 11 as a pair thereof so as to face each other.

The inspection hole 12 of the crucible 10 may be covered with a transparent window 13 to seal the internal space 11. Therefore, heat insulation effects of the internal space 11 may be increased. The transparent window 13 may be formed of any material, as long as the material is transparent and heat resistant.

The heating unit 14 may be disposed in the crucible 10. As long as the heating unit 14 activates the internal space 11 under the high temperature conditions by various methods, any heating unit may be used as the heating unit 14. For example, the heating unit 14 may be a heating wire heated by electrical power supply or a ventilation fan generating hot air. However, the heating unit 14 is not limited thereto.

In the case in which the heating unit 14 includes all types of heating units heated by electrical power supply, such as a heating wire, a coil, and the like, the heating wire may be provided to be molded in a bottom surface or a side wall of the crucible 10 forming the internal space 11. Although not illustrated in the drawings, the heating unit 14 may be connected to an external power supply.

Meanwhile, the crucible 10 may be enclosed by a heating block 40. The heating block 40 may improve the heat insulation effect of the crucible 10. Further, the crucible 10 may be further enclosed by a heat insulation material 41.

The indenter tip 20 may be protruded inwardly from the outside of the crucible 10 to the internal space 11. The indenter tip 20 is disposed in the crucible 10 so as to move longitudinally, such that the substrate 5 fixed to the internal space 11 may be warped. In more detail, the indenter tip 20 may pressurize an edge portion of the substrate 5, such that the substrate 5 may be warped by an amount equal to a target displacement. In addition, the indenter tip 20 may be provided to apply pressure to a surface of the substrate 5 in a vertical direction.

Therefore, the indenter tip 20 may be disposed in an actuator 21 such that the indenter tip 20 may move longitudinally. In the present embodiment, the displacement of the substrate 15 may be significantly small, for example, several nm, and an actuator allowing for fine displacement may be used. For example, the actuator 21 may be a piezo actuator using a piezo element of which a length is changed by the supply of power. Alternatively, the actuator 21 may be an actuator using a linear motor based on an electromagnet method. The actuator 21 is not limited thereto, and therefore various actuators may be used. Although not illustrated in the drawings, the actuator 21 may be connected to an external power supply.

A leading end of the indenter tip 20 may have a hemispherical shape as illustrated in the drawings. The leading end of the indenter tip 20 is not limited thereto, and therefore may have a conical shape or a polygonal pyramid shape, such as a trigonal pyramid, and the like. Further, a portion of the indenter tip 20 contacting the substrate 5 may be manufactured to have various sizes from several nm to several mm by using a focused ion beam, and the like. In addition, the outside of the indenter tip 20 is provided with a load cell to inspect a degree of force applied when the indenter tip 20 moves by an amount equal to a predetermined displacement. The load cell may be connected to the control unit 50.

The inspection unit 30 may be disposed above the inspection hole 12. The inspection unit 30 may include an objective lens 31. The objective lens 31 may be disposed on the inspection unit 30 in a direction of the inspection hole 12 to thereby inspect the edge portion of the substrate 5 disposed in the internal space 11. Further, the inspection unit 30 may record inspected contents or may store the inspected contents on electronic media. The inspected contents may be displayed as an image in real time.

As the inspection unit 30, any inspection unit may be used as long as it includes the objective lens 31. For example, microscopes such as a scanning electron microscope, an optical microscope, and the like, can be used. Further, a high pixel camera may also be used, depending on inspection objects.

Further, the inspection unit 30 may be disposed in the crucible 10 or may be separately disposed.

Meanwhile, various components may be controlled by the control unit 50. That is, the heating unit 14, the actuator 21, and the inspection unit 30 are connected to the control unit 50 in a wired or wireless manner, such that operations of thereof may be controlled according to commands of the control unit 50. For example, the control unit 50 may be connected to the heating unit 14, the actuator 21, and the inspection unit 30 by a heating unit control line 51, an actuator control line 52, and an inspection unit control line 53, respectively. The control unit 50 may also control respective components in a wireless manner.

Describing in detail, the control unit 50 may be interconnected with the indenter tip 20 to control movements of the indenter tip 20. In more detail, the control unit 50 may be connected to the actuator 21 providing longitudinal driving force of the indenter tip 20 in a wired or wireless manner. The control unit 50 may move the indenter tip 20 by an amount equal to the target displacement by a user's input. In addition, the control unit 50 may determine force applied to the indenter tip 20 according to displacement of the indenter tip 20 and determine the correlation therebetween to store the determined results in a memory.

Further, the control unit 50 may control the objective lens 31 of the inspection unit 30 to move toward the edge, that is, a target cross-section of the substrate 5 and may command that the data generated by the inspection unit 30 may be stored in the memory.

Further, the control unit 50 may control the heating unit 14 to heat the internal space 11 to a target temperature.

Meanwhile, in the present invention, the control unit 50 may be disposed in electronic devices. An example of the electronic devices may include a computer (including a desk top computer, a laptop computer), a mobile phone, a smart phone, personal digital assistants (PDAs), a portable multimedia player (PMP), and the like. Further, it can be easily understood by those skilled in the art that the configuration according to the embodiments described in the present specification may be applied to portable terminals such as portable electronic devices as well as fixed terminals such as a desk top computer. Further, the electronic devices may include a memory and the control unit 50 and the memory may interwork with each other.

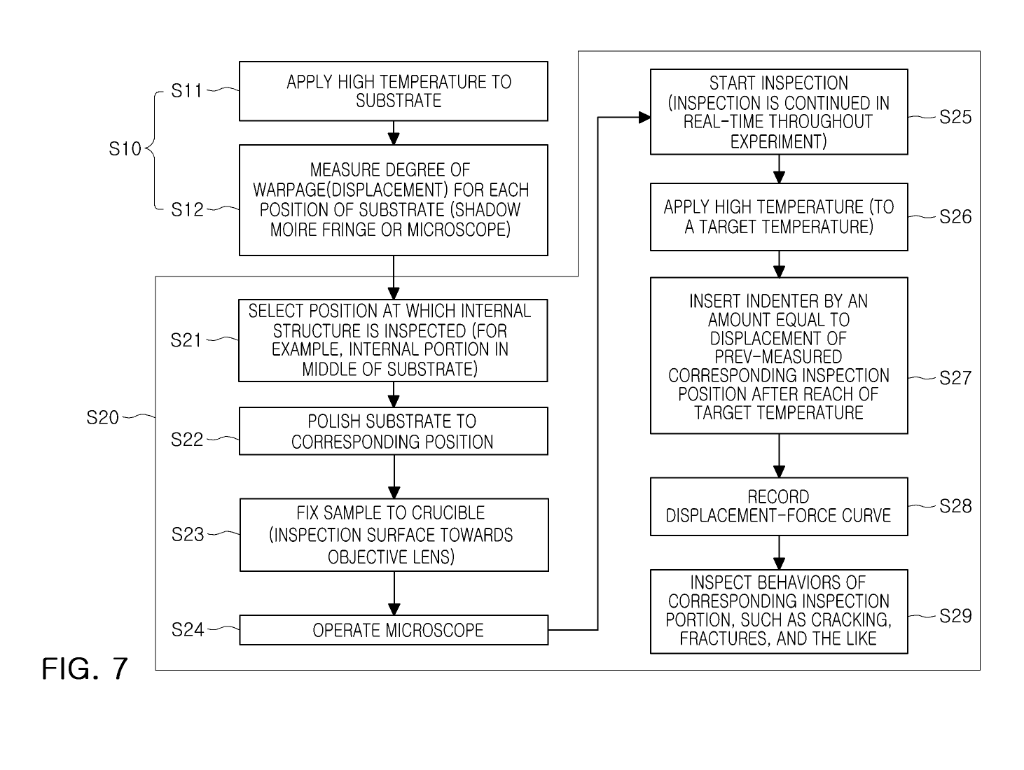

FIG. 7 is a flow chart illustrating a sequence of an inspection method for substrate deformation at high temperatures according to an embodiment of the present invention. The inspection method for substrate deformation at high temperatures according to the present embodiment may be performed using the inspection device 100 for substrate deformation at high temperatures according to the present embodiment.

Referring to FIG. 7, the inspection method for substrate deformation at high temperatures according to the present embodiment may include two operations. First, the inspection method includes measuring warpage deformation of substrate to be subjected to high temperature deformation inspection to database the measured warpage deformation (S10) and second, inspecting deformation due to a thermal load in the target cross-section of the substrate using the databased warpage deformation of the substrate (S20).

First, measuring the warpage deformation of the substrate to be subjected to high temperature deformation inspection to database the measured warpage deformation (S10) will be described.

First, after the substrate is disposed in the predetermined space, target temperature conditions may be created (S11). If the predetermined space may activate the high temperature conditions, any space may be used without being limited. For example, various spaces, such as a sealed crucible, a sealed chamber, and the like, may be used. If the substrate is under high temperature conditions, as illustrated in FIG. 1, warpage deformation occurs.

Next, the warpage deformation of the substrate may be measured at the high temperature conditions (S12). Various tools may be used to measure the warpage deformation of the substrate. For example, a shadow moire fringe, a microscope, or the like may be used. In addition to this, various known methods may be used. The warpage deformation of the substrate at the high temperature conditions may be databased and stored in the memory.

Meanwhile, referring to FIG. 3, in the central portion of the substrate, since displacement is ‘0’ in case of the cut (or polished, hereinafter referred to the same meaning) substrate, the displacement applied to the substrate by the indenter tip in S20 to be described below may be calculated, as long as the displacement of the substrate prior to the cutting may be obtained. However, in the cut substrate cut along line A-A′, the remainder portion other than the central portion of the cut surface does not have the displacement of ‘0’, such that there may be a limitation in calculating the displacement applied to the substrate only with the displacement of the substrate prior to the cutting. Therefore, measuring the warpage deformation of the substrate to be subjected to high temperature deformation inspection to database the measured warpage deformation (S10) may include databasing the warpage deformation of the substrate cut along the target cross-section and storing the databased warpage deformation in the memory.

Therefore, as illustrated in FIG. 3, a target displacement Dt can be understood from deformation curves of the substrate before the cutting thereof and the substrate after the cutting thereof, formed taken along line A-A′. Describing in detail, in the case of inspecting internal deformation of a predetermined portion of the substrate, for example, taken along line A-A′, a difference between a Y-axis deformation of the substrate before the cutting thereof and a Y-axis deformation of the substrate after the cutting thereof in the predetermined portion thereof may correspond to the target displacement Dt.

Meanwhile, measuring the warpage deformation of the substrate to be subjected to high temperature deformation inspection to database the measured warpage deformation (S10) may be entirely controlled according to commands of the control unit 50. Further, inspecting deformation due to a thermal load in the target cross-section of the substrate using the databased warpage deformation of the substrate (S20) may be entirely controlled according to the commands of the control unit 50.

Further, the deformation due to a thermal load in the target cross-section of the substrate may be inspected using the databased warpage deformation (S20).

First, a position of the substrate at which the internal structure thereof is inspected may be selected (S21). Generally, stress is concentrated on the central portion of the substrate, such that cracks or delamination may easily occur therein, thereby inspecting the internal structure of the central portion of the substrate.

Next, the substrate may be cut or polished so as to expose the target cross-section to be inspected (S22).

Next, the substrate may be disposed in the internal space 11 of the crucible 10 such that the cut or polished target cross-section is disposed in a direction toward the inspected groove 12 (S23). In this case, the substrate may be fitted in the seating grooves 15 of the crucible 10.

Next, the inspection unit 30, for example, a microscope may be operated to inspect the target cross-section of the substrate and the inspection may be undertaken without interruption thereof during an experiment period (S24 and S25). Further, the portion of the substrate inspected by the inspection unit 30 may be displayed by the display unit in real time and may be stored in the memory.

Next, the heating unit 14 is operated so that the internal space 11 may be activated to have the high temperature conditions of the target temperature.

Next, when the internal space 11 reaches the target temperature, the edge portion of the substrate is pressurized by the indenter tip 20 to cause the warpage deformation of substrate (S27). In this case, the indenter tip 20 may be pressurized by amount equal to the calculated target displacement (Dt) with reference to the graph written in a manner as illustrated in FIG. 3.

Next, a displacement-force curve may be formed by determining the force required to pressurize the indenter tip 20 by an amount equal to target displacement Dt (S28). The force may be calculated using the load cell disposed in the actuator 21 or disposed in the indenter tip 20.

Finally, the target cross-section of the substrate in which the warpage deformation occurs may be inspected by the inspection unit 30 (S29). In this case, the inspection unit 30 is continuously inspected before the warpage deformation of substrate occurs, such that it is possible to continuously inspect the target cross-section from the time at which the warpage deformation occurs to the user-desired time. The user may fetch records stored in the memory to freely inspect the behaviors of the substrate in the target cross-section, such as cracks, fractures, and the like, in real time.

As set forth above, according to the embodiments of the present invention, the behaviors of the substrate in association with internal deformation thereof at high temperatures can be inspected using a simple tester.

While the present invention has been shown and described in connection with the embodiments, it will be apparent to those skilled in the art that modifications and variations can be made without departing from the spirit and scope of the invention as defined by the appended claims.

What is claimed is:

1. An inspection device for substrate deformation at high temperatures, comprising:
a crucible including an internal space, an inspection hole disposed in an upper portion thereof so as to inspect the internal space, and a heating unit heating the internal space;
an indenter tip disposed in the crucible such that a substrate fixed to the internal space is warped; and
an inspection unit disposed above the crucible so as to inspect a cross-section of the substrate.

2. The inspection device of claim 1, wherein the inspection hole is covered with a transparent window.

3. The inspection device of claim 1, wherein the crucible is enclosed by a heat insulation material.

4. The inspection device of claim 1, further comprising a control unit interconnected with the indenter tip to control movements of the indenter tip.

5. The inspection device of claim 4, wherein the control unit determines force applied to the indenter tip according to displacement of the indenter tip and determines correlation therebetween to store determined results in a memory.

6. The inspection device of claim 4, wherein the control unit controls an objective lens of the inspection unit to move toward a target cross-section of the substrate and allows data inspected by the inspection unit to be stored in a memory.

7. The inspection device of claim 4, wherein the control unit controls the heating unit to heat the internal space to a target temperature.

8. The inspection device of claim 1, wherein the crucible is provided with seating grooves opposing each other and having both ends of the substrate fitted therein to be fixed thereto.

9. An inspection method for substrate deformation at high temperatures, the inspection method comprising:
heating a crucible including an internal space having a substrate mounted therein and polished so as to expose a target cross-section of the substrate, to a target temperature;
warping the target cross-section of the substrate to a target displacement by an indenter tip disposed in the crucible; and
inspecting the target cross-section by an inspection unit.

10. The inspection method of claim 9, wherein the target displacement is a difference between degrees of deformation in the target cross-section of the substrate before the substrate is polished and the target cross-section of the substrate after the substrate is polished, at the target temperature.

11. The inspection method of claim 10, wherein the target cross-section includes a central portion of the substrate before the substrate is polished.

12. The inspection method of claim 9, wherein the warping includes measuring force applied to move the substrate by an amount equal to the target displacement by the indenter tip.
